(19) United States
(12) Patent Application Publication
(10) Pub. No.: US 2012/0202624 A1
(43) Pub. Date: Aug. 9, 2012

(54) Basketball Backboard Systems and Methods

(76) Inventor: KarlVan Davis, Houston, TX (US)

(21) Appl. No.: 13/023,203

(22) Filed: Feb. 8, 2011

(51) Int. Cl. A63B 63/08; B23P 11/00

(52) U.S. Cl. 473/485; 29/428

(57) ABSTRACT

There is disclosed a system comprising a basketball backboard; a basketball rim; a support structure connecting the backboard to the rim; a first space bounded by a left side of the backboard, a left side of the support structure, and a left side of the rim; a first stopper occupying at least a portion of the first space; a second space bounded by a right side of the backboard, a right side of the support structure, and a right side of the rim; and a second stopper occupying at least a portion of the second space.

### FIELD OF THE INVENTION

The present invention relates to systems and methods for using and playing basketball on a backboard and rim assembly.

### DESCRIPTION OF THE RELATED ART

U.S. Pat. No. 7,419,445 discloses a basketball backboard that includes one or more weights disposed proximate the perimeter of the backboard in order to enhance the rebounding characteristics of the backboard. A first weight may be positioned proximate a first side of the backboard and a second weight may be positioned proximate a second side of the backboard in order to enhance the rebounding characteristics of the backboard. The weights may be positioned internally within the backboard or the weights may be positioned externally to the backboard. The weights may be selectively or permanently attached to the backboard, and the weights may also be sized and configured to increase the rigidity of the basketball backboard. U.S. Pat. No. 7,419,445 is herein incorporated by reference in its entirety.

U.S. Pat. No. 6,824,481 discloses a basketball goal assembly which includes a basketball goal with a strike plate. The strike plate includes a rebound surface support that is sized and configured to help prevent the backboard from undesirably flexing or bending. The strike plate allows forces to be directly transmitted from the backboard to other structures such as a backboard bracket or goal support structure. The strike plate also has one or more flexural supports that brace the strike plate against flexure so that impact received from the rebound surface via the rebound surface support does not excessively bend the strike plate. U.S. Pat. No. 6,824,481 is herein incorporated by reference in its entirety.

U.S. Pat. No. 6,080,071 discloses a breakaway basketball rim assembly in which there is a release assembly which operably interconnects the base member and the rim member, the release assembly being configured to release the rim member in response to a downward load which is received at any point along an extended frontal arc of the circular hoop portion, so that the hoop tilts downwardly generally in the direction of the load. There is also a reaction load mechanism for returning the hoop to its horizontal playing position. A U-shaped fulcrum joint extends between the reaction load in the hoop so as to provide a pivot point in line between the reaction load and any impact point along the extended frontal arc of the hoop. The joint is configured so that the rim releases in response to a substantially identical impact load anywhere along the frontal arc. The rim comprises a rim portion, a backboard mounting portion, and bolts for securing the rim portion to the mounting portion. The rim portion has a ring with a lower surface. A plurality of tubes are mounted on the lower surface of a ring with gaps between adjacent tubes. Openings extend through the tubes. An elongated member extends through the tube. A net is suspended from the rim portion by placing an upper loop of the net in a gap between any given pair of adjacent tubes and inserting the elongate member through the given pair of adjacent tubes. U.S. Pat. No. 6,080,071 is herein incorporated by reference in its entirety.

U.S. Pat. No. 5,830,090 discloses a basketball goal unit having a first mounting plate for attachment to a backboard, a second mounting plate pivotally mounted to the first mounting plate, a rim supported from the second mounting plate, and a resilient member located between and in contact with the first and second mounting plates, the resilient member acting to bias the second mounting plate to a normal use position, wherein the resilient member is compressed and the second mounting plate is permitted to pivot a specified amount toward the first mounting plate when the rim receives a force having a downward component greater than a threshold level. Thereafter, the second mounting plate automatically pivots back to its normal use position due to the biasing action of the resilient member. Additionally, a rim support mechanism including a first support arm attached at a first end to a first side flange of the second mounting plate and to the rim at a second end, as well as a second support arm attached at a first end to a second side flange of the second mounting plate and to the rim at a second end, may be provided to assist in stabilizing the rim in a normal use position. A flexible cover for enclosing an area defined between the first and second mounting plates may also be provided to enclose the resilient member. U.S. Pat. No. 5,830,090 is herein incorporated by reference in its entirety.

From time to time in a basketball game, the basketball may become lodged between the rim and the backboard. This is an inconvenience to the players and causes a stoppage of play. First, the basketball must be retrieved from its lodged position, and a jump ball is needed to determine which team will have possession of the ball. There is a need in the art for systems and methods to keep basketballs from becoming lodged between the rim and the backboard.

Referring now to FIG. 1, there is shown a prior art basketball system 100. System 100 includes a backboard 102, connected to a goal or rim 104 by a support structure 106. The object of the game is to shoot the ball 108 into the goal 104. From time to time during the game, ball 108 may get stuck between a goal 104 and backboard 102. The ball 108 getting stuck between goal 104 and backboard 102 can occur on either side of the goal as shown in FIG. 1

There is a need in the art for systems and methods to prevent a ball from getting stuck between a basketball goal and a basketball backboard.

These and other needs in the art will become apparent to those of skill in the art upon review of this specification, including its drawings and claims.

### SUMMARY OF THE INVENTION

One aspect of invention provides a system comprising a basketball backboard; a basketball rim; a support structure connecting the backboard to the rim; a first space bounded by a left side of the backboard, a left side of the support structure, and a left side of the rim; a first stopper occupying at least a portion of the first space; a second space bounded by a right side of the backboard, a right side of the support structure, and a right side of the rim; and a second stopper occupying at least a portion of the second space.

Another aspect of invention provides a system comprising a basketball backboard; a basketball rim; a support structure connecting the backboard to the rim; a space bounded by a right side of the backboard, a right side of the support structure, and a right side of the rim; wherein a basketball that was stuck between the right side of the backboard and the right side of the rim would define a basketball circumference; and a stopper occupying at least a portion of the space and having a first portion outside the basketball circumference, and a second portion extending across the basketball circumference to keep the basketball from getting stuck between the right side of the backboard and the right side of the rim.

Another aspect of invention provides a method comprising attaching a basketball rim to a support structure; attaching the support structure and the rim to a basketball backboard; attaching a stopper to at least one of the support structure, the rim, and the backboard, the stopper adapted to prevent a basketball from getting stuck in a space bounded by the backboard, the support structure, and the rim.

These and other aspects of the invention will become apparent to those of skill in the art upon review of this specification, including its drawings and claims.

### BRIEF DESCRIPTION OF THE DRAWINGS

FIG. 1 shows a top view of a prior art basketball goal and backboard assembly.

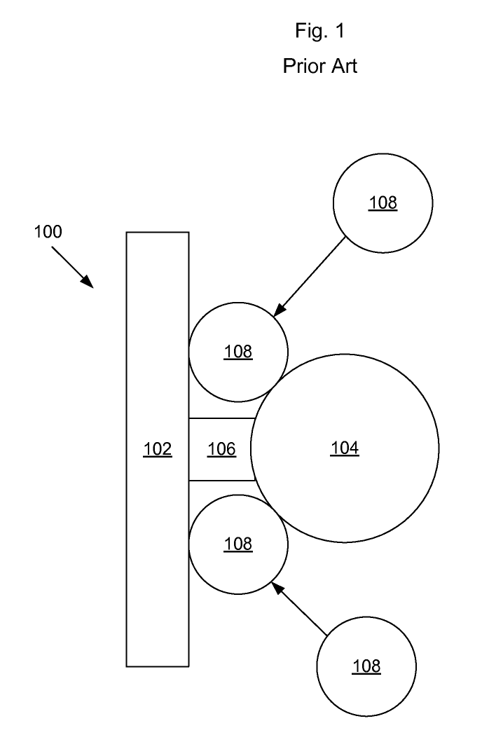

FIG. 2a shows a top view of a basketball goal and backboard assembly according to one embodiment of the invention.

FIG. 2b shows a side view of a basketball goal and backboard assembly according to one embodiment of the invention.

FIG. 3 shows a top view of a basketball goal and backboard assembly according to another embodiment of the invention.

FIG. 4 shows a top view of a basketball goal and backboard assembly according to another embodiment of the invention.

### DETAILED DESCRIPTION OF THE INVENTION

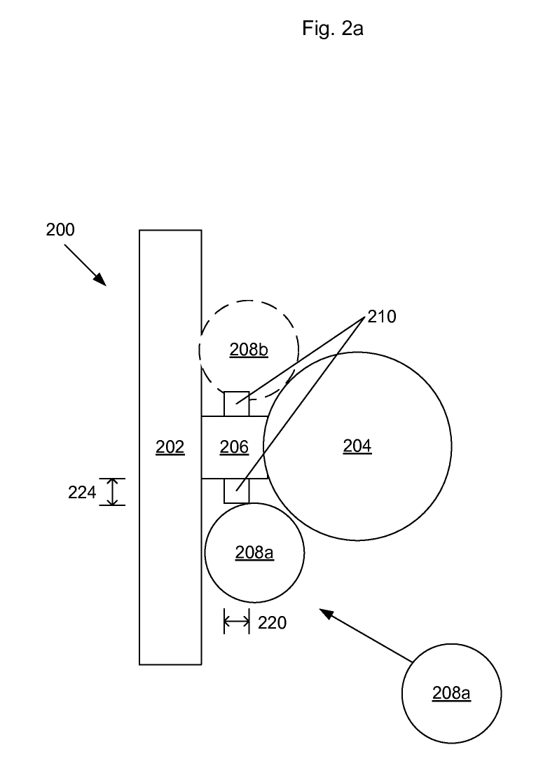

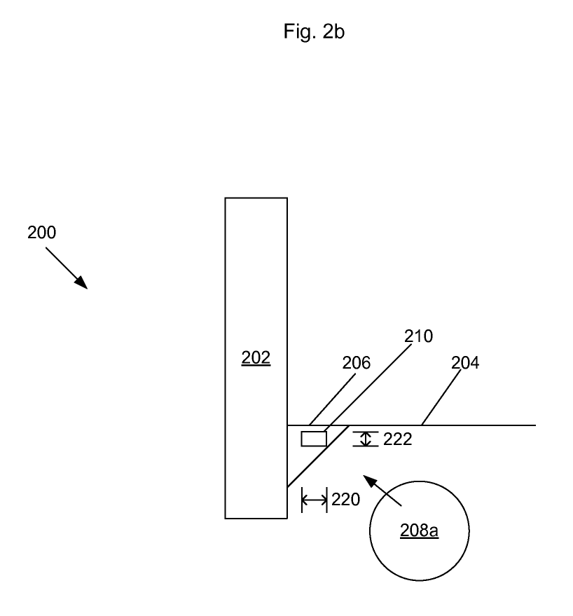

### FIGS. 2a & 2b:

Referring now to FIGS. 2a and 2b, there is shown basketball system 200. FIG. 2a is a top view of system 200, and FIG. 2b is a side view of system 200. System 200 includes a backboard 202, connected to a goal or rim 204 by a support structure 206. The object of the game is to shoot the ball 208a into the goal 204. From time to time during the game, a ball 208a may be shot or thrown with such a trajectory as to get stuck between a goal 204 and backboard 202. To prevent the ball 208a from getting stuck between goal 204 and backboard 202, a stopper 210 is provided on either side of the goal as shown in FIG. 2.

In some embodiments, the goal 204 may have a diameter from about 17 to about 18 inches, ball 208a may have a diameter from about 9 to about 10 inches, and a goal 204 may be offset from the backboard 202 by a distance of about 6 inches. In other embodiments, a goal 204, ball 208a, backboard 202, and support structure 206 may be smaller or larger as desired by the players of the game.

In some embodiments, backboard 202 may be glass, acrylic, polymer, steel, or other material as are known in the basketball backboard arts. In some embodiments, the goal 204 may be steel, aluminum, or another high strength material as are known in the basketball rim arts. In some embodiments, support structure 206 may be a static structure such as steel reinforcing plates and rods, or in other embodiments, support structure 206 may be a dynamic structure to provide for a breakaway rim 204 for the occurrence when a player hangs from the goal 204.

In some embodiments, stopper 210 may have a length 224 from about 1 to about 6 inches, for example from about 2 to about 4 inches, or from about 2.5 to about 3 inches. In some embodiments, stopper 210 may have a width 220 from about 0.5 to about 6 inches, for example from about 1 to about 4 inches, or from about 2 to about 3 inches. In some embodiments, stopper 210 may have a height 222 from about 0.25 to about 6 inches, for example from about 0.5 to about 4 inches, or from about 1 to about 2 inches.

In some embodiments, stopper 210 may have sufficient dimensions to cross a circumference of ball 208b that could be stuck between backboard 202 and goal 204. In such a case, ball 208b would bounce off of stopper 210 before becoming stuck between backboard 202 and goal 204. Stopper 210 may cross circumference by a distance from about a 0.1 to about 1 inches, for example from about 0.2 to about 0.8 inches, or from about 0.25 to about 0.5 inches.

In some embodiments, there is a desire to provide a sufficiently large stopper 210 to prevent the ball 208b from getting stuck between backboard 202 and goal 204, while at the same time limiting the size of stopper 210, to keep stopper 210 from interfering with shots that may be going into goal 204.

In some embodiments, stopper 210 may be made of the same material as goal 204, support structure 206, or backboard 202. In some embodiments, stopper 210 may be manufactured integrally with support structure 206. In some embodiments, stopper 210 may be retrofitted up to an existing support structure 206, for example with welding, gluing, bolts, or other mechanical connection means as are known in the art.

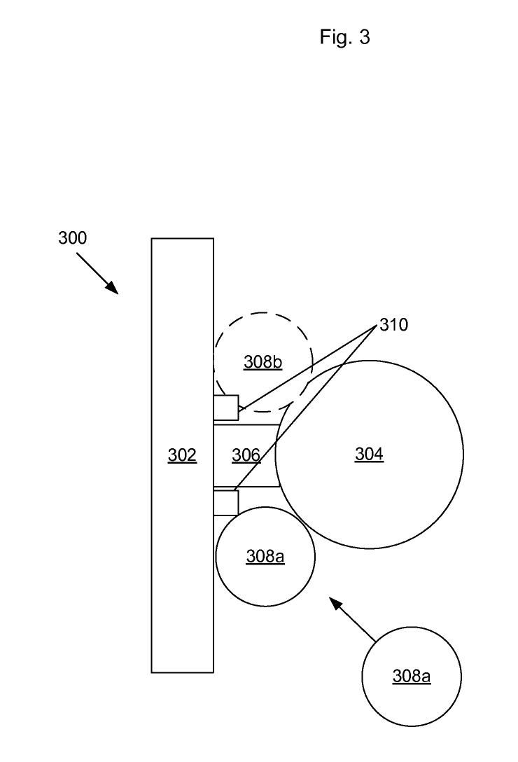

### FIG. 3:

Referring now to FIG. 3, there is shown a top view of basketball system 300. System 300 includes a backboard 302, connected to a goal or rim 304 by a support structure 306. The object of the game is to shoot the ball 308a into the goal 304. From time to time during the game, a ball 308a may be shot or thrown with such a trajectory as to get stuck between a goal 304 and backboard 302. To prevent the ball 308a from getting stuck between goal 304 and backboard 302, a stopper 310 is provided on either side of the goal as shown in FIG. 3.

In some embodiments, the goal 304 may have a diameter from about 17 to about 18 inches, ball 308a may have a diameter from about 9 to about 10 inches, and a goal 304 may be offset from the backboard 302 by a distance of about 6 inches. In other embodiments, a goal 304, ball 308a, backboard 302, and support structure 306 may be smaller or larger as desired by the players of the game.

In some embodiments, backboard 302 may be a glass, acrylic, polymer, steel, or other material as are known in the basketball backboard arts. In some embodiments, the goal 304 may be steel, aluminum, or another high strength material as are known in the basketball rim arts. In some embodiments, support structure 306 may be a static structure such as steel reinforcing plates and rods, or in other embodiments, support structure 306 may be a dynamic structure to provide for a breakaway rim 304 for the occurrence when a player hangs from the goal 304.

In some embodiments, stopper 310 may have a length (extending out from and measured perpendicular to the face of backboard 302) from about 1 to about 6 inches, for example from about 2 to about 4 inches, or from about 2.5 to about 3 inches. In some embodiments, stopper 310 may have a width (extending horizontally along the face of and measured parallel to the face of backboard 302) from about 0.5 to about 6 inches, for example from about 1 to about 4 inches, or from about 2 to about 3 inches. In some embodiments, stopper 310 may have a height (extending vertically along the face of backboard 302 and measured along a line from the ground to the top of backboard 302) from about 0.25 to about 6 inches, for example from about 0.5 to about 4 inches, or from about 1 to about 2 inches.

In some embodiments, stopper 310 may have sufficient dimensions to cross a circumference of ball 308b that could be stuck between backboard 302 and goal 304. In such a case, ball 308b would bounce off of stopper 310 before becoming stuck between backboard 302 and goal 304. Stopper 310 may cross circumference by a distance from about a 0.1 to about 1 inches, for example from about 0.2 to about 0.8 inches, or from about 0.25 to about 0.5 inches.

In some embodiments, there is a desire to provide a sufficiently large stopper 310 to prevent the ball 308b from getting stuck between backboard 302 and goal 304, while at the same time limiting the size of stopper 310, to keep stopper 310 from interfering with shots that may be going into goal 304.

In some embodiments, stopper 310 may be made of the same material as goal 304, support structure 306, or backboard 302. In some embodiments, stopper 310 may be manufactured integrally with backboard 302. In some embodiments, stopper 310 may be retrofitted up to an existing backboard 302, for example with welding, gluing, bolts, or other mechanical connection means as are known in the art.

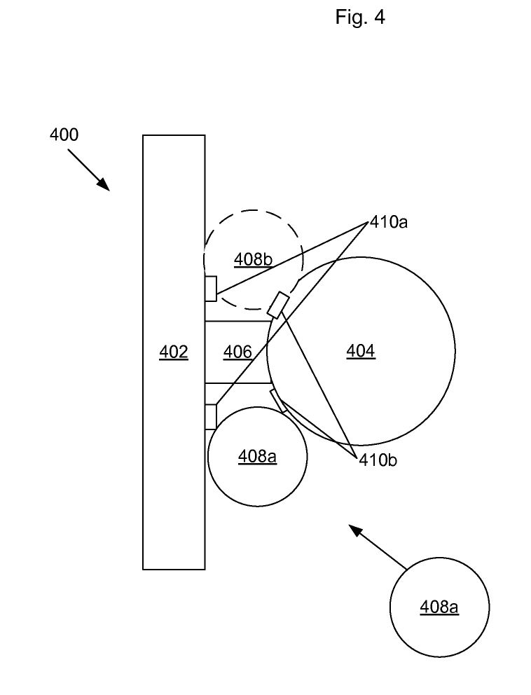

### FIG. 4:

Referring now to FIG. 4, there is shown a top view of basketball system 400. System 400 includes a backboard 402, connected to a goal or rim 404 by a support structure 406. The object of the game is to shoot the ball 408a into the goal 404. From time to time during the game, a ball 408a may be shot or thrown with such a trajectory as to get stuck between a goal 404 and backboard 402. To prevent the ball 408a from getting stuck between goal 404 and backboard 402, two stopper portions 410a and 410b are provided on either side of the goal as shown in FIG. 4.

In some embodiments, stopper 410a may have a length (extending out from and measured perpendicular to the face of backboard 402) from about 0.25 to about 3 inches, for example from about 0.5 to about 2 inches, or from about 1 to about 2 inches. In some embodiments, stopper 410a may have a width (extending horizontally along the face of and measured parallel to the face of backboard 402) from about 0.5 to about 6 inches, for example from about 1 to about 4 inches, or from about 2 to about 3 inches. In some embodiments, stopper 410a may have a height (extending vertically along the face of the backboard and measured along a line from the ground to the top of backboard 402) from about 0.25 to about 6 inches, for example from about 0.5 to about 4 inches, or from about 1 to about 2 inches.

In some embodiments, stopper 410b may have a length (measured radially from the center of goal 404) from about 0.25 to about 3 inches, for example from about 0.5 to about 2 inches, or from about 1 to about 2 inches. In some embodiments, stopper 410b may have a width (measured along an arc of the circumference of goal 404) from about 0.5 to about 6 inches, for example from about 1 to about 4 inches, or from about 2 to about 3 inches. In some embodiments, stopper 410b may have a height (measured along a line from the ground to the top of goal 404) from about 0.25 to about 3 inches, for example from about 0.5 to about 2 inches, or from about 0.75 to about 1 inches.

In some embodiments, stopper portions 410a and 410b may have sufficient dimensions to cross a circumference of ball 408b that could be stuck between backboard 402 and goal 404. In such a case, ball 408b would bounce off of stopper 410a and/or stopper 410b before becoming stuck between backboard 402 and goal 404. Stopper portions 410a and 410b may each cross circumference by a distance from about a 0.1 to about 1 inches, for example from about 0.2 to about 0.8 inches, or from about 0.25 to about 0.5 inches.

In some embodiments, there is a desire to provide sufficiently large stopper portions 410a and 410b to prevent the ball 408b from getting stuck between backboard 402 and goal 404, while at the same time limiting the size of stopper portions 410a and 410b, to keep stopper portions 410a and 410b from interfering with shots that may be going into goal 404.

In some embodiments, stopper portions 410a and 410b may be made of the same material as goal 404, support structure 406, and/or backboard 402. In some embodiments, stopper portion 410a may be manufactured integrally with backboard 402, and stopper portion 410b may be manufactured integrally with goal 404. In some embodiments, stopper portion 410a may be retrofitted up to an existing backboard 402, and stopper portion 410b may be retrofitted up to an existing goal 404, for example with welding, gluing, bolts, or other mechanical connection means as are known in the art.

### Illustrative Embodiments

In one embodiment, there is disclosed a system comprising a basketball backboard; a basketball rim; a support structure connecting the backboard to the rim; a first space bounded by a left side of the backboard, a left side of the support structure, and a left side of the rim; a first stopper occupying at least a portion of the first space; a second space bounded by a right side of the backboard, a right side of the support structure, and a right side of the rim; and a second stopper occupying at least a portion of the second space. In some embodiments, the rim has a diameter from about 15 to about 20 inches. In some embodiments, the rim is a distance from about 5 to about 8 inches from the backboard. In some embodiments, the first stopper and the second stopper have a length from about 2 to about 5 inches. In some embodiments, the first stopper is connected to the left side of the support structure, and the second stopper is connected to the right side of the support structure. In some embodiments, the first stopper is connected to the left side of the backboard, and the second stopper is connected to the right side of the backboard.

In one embodiment, there is disclosed a system comprising a basketball backboard; a basketball rim; a support structure connecting the backboard to the rim; a space bounded by a right side of the backboard, a right side of the support structure, and a right side of the rim; wherein a basketball that was stuck between the right side of the backboard and the right side of the rim would define a basketball circumference; and a stopper occupying at least a portion of the space and having a first portion outside the basketball circumference, and a second portion extending across the basketball circumference to keep the basketball from getting stuck between the right side of the backboard and the right side of the rim. In some embodiments, the rim has a diameter from about 16 to about 19 inches. In some embodiments, the rim is a distance from about 5.5 to about 7 inches from the backboard. In some embodiments, the stopper has a length from about 3 to about 6 inches. In some embodiments, the stopper is connected to the right side of the support structure. In some embodiments, the stopper is connected to the right side of the backboard. In some embodiments, the second portion of the stopper extends across the basketball circumference a distance from about 0.25 to about 2 inches.

In one embodiment, there is disclosed a method comprising attaching a basketball rim to a support structure; attaching the support structure and the rim to a basketball backboard; attaching a stopper to at least one of the support structure, the rim, and the backboard, the stopper adapted to prevent a basketball from getting stuck in a space bounded by the backboard, the support structure, and the rim. In some embodiments, the method also includes mounting the support structure, the rim, and the backboard at a height of about 7 feet to about 11 feet above a playing surface. In some embodiments, the method also includes mounting the rim at a height of about 9.5 feet to about 10.5 feet above a playing surface. In some embodiments, the stopper has a length from about 1 to about 4 inches.

While the various embodiments of the invention have been described with particularity, it will be understood that various other modifications will be apparent to and can be readily made by those skilled in the art without departing from the spirit and scope of the invention. Accordingly, it is not intended that the scope of the claims appended hereto be limited to the examples and descriptions set forth herein but rather that the claims be construed as encompassing all the features of patentable novelty which reside in the invention, including all features which would be treated as equivalents thereof by those skilled in the art to which this invention pertains.

I claim:

1. A system comprising:
a basketball backboard;
a basketball rim;
a support structure connecting the backboard to the rim;
a first space bounded by a left side of the backboard, a left side of the support structure, and a left side of the rim;
a first stopper occupying at least a portion of the first space;
a second space bounded by a right side of the backboard, a right side of the support structure, and a right side of the rim; and
a second stopper occupying at least a portion of the second space.

2. The system of claim 1, wherein the rim has a diameter from about 15 to about 20 inches.

3. The system of claim 1, wherein the rim is a distance from about 5 to about 8 inches from the backboard.

4. The system of claim 1, wherein the first stopper and the second stopper have a length from about 2 to about 5 inches.

5. The system of claim 1, wherein the first stopper is connected to the left side of the support structure, and the second stopper is connected to the right side of the support structure.

6. The system of claim 1, wherein the first stopper is connected to the left side of the backboard, and the second stopper is connected to the right side of the backboard.

7. A system comprising:
a basketball backboard;
a basketball rim;
a support structure connecting the backboard to the rim;
a space bounded by a right side of the backboard, a right side of the support structure, and a right side of the rim;
wherein a basketball that was stuck between the right side of the backboard and the right side of the rim would define a basketball circumference; and
a stopper occupying at least a portion of the space and having a first portion outside the basketball circumference, and a second portion extending across the basketball circumference to keep the basketball from getting stuck between the right side of the backboard and the right side of the rim.

8. The system of claim 7, wherein the rim has a diameter from about 16 to about 19 inches.

9. The system of claim 7, wherein the rim is a distance from about 5.5 to about 7 inches from the backboard.

10. The system of claim 7, wherein the stopper has a length from about 3 to about 6 inches.

11. The system of claim 7, wherein the stopper is connected to the right side of the support structure.

12. The system of claim 7, wherein the stopper is connected to the right side of the backboard.

13. The system of claim 7, wherein the second portion of the stopper extends across the basketball circumference a distance from about 0.25 to about 2 inches.

14. A method comprising:
attaching a basketball rim to a support structure;
attaching the support structure and the rim to a basketball backboard;
attaching a stopper to at least one of the support structure, the rim, and the backboard, the stopper adapted to prevent a basketball from getting stuck in a space bounded by the backboard, the support structure, and the rim.

15. The method of claim 14, further comprising mounting the support structure, the rim, and the backboard at a height of about 7 feet to about 11 feet above a playing surface.

16. The method of claim 14, further comprising mounting the rim at a height of about 9.5 feet to about 10.5 feet above a playing surface.

17. The method of claim 14, wherein the stopper has a length from about 1 to about 4 inches.
